(19) United States
(12) Patent Application Publication
(10) Pub. No.: US 2023/0081941 A1
(43) Pub. Date: Mar. 16, 2023

(54) SYSTEMS AND METHODS FOR PAIRING WIRELESS POWER RECEIVERS AND TRANSMITTERS

(71) Applicant: WiTricity Corporation, Watertown, MA (US)

(72) Inventor: David DeBaun, Westford, MA (US)

(21) Appl. No.: 17/943,990

(22) Filed: Sep. 13, 2022

Related U.S. Application Data
(60) Provisional application No. 63/243,942, filed on Sep. 14, 2021.

(51) Int. Cl. B60L 53/126; H02J 50/12; H02J 50/90; H02J 50/80

(52) U.S. Cl. CPC B60L 53/126; H02J 50/12; H02J 50/90; H02J 50/80

(57) ABSTRACT

A method for pairing a wireless power receiver to a wireless power transmitter, the wireless power receiver being configured to charge a battery of a vehicle. The method includes accessing, identification information associated with a communication channel corresponding to a designated wireless power transmitter of a plurality of wireless power transmitters, establishing, by the wireless power receiver, a wireless connection with the designated wireless power transmitter, based on the identification information associated with the communication channel, receiving, by the wireless power receiver over the wireless connection, alignment information from the designated wireless power transmitter, detecting that the vehicle has parked proximate to the designated wireless power transmitter according to the alignment information, and verifying that the wireless power receiver is authorized to receive power from the designated wireless power transmitter to charge the battery of the vehicle.

### CROSS-REFERENCE TO RELATED APPLICATIONS

This application claims priority to U.S. Provisional Application No. 63/243,942, filed Sep. 14, 2021 and titled “SYSTEMS AND METHODS FOR PAIRING WIRELESS POWER RECEIVERS AND TRANSMITTERS,” the entire contents of which are incorporated by reference.

### TECHNICAL FIELD

The following disclosure is directed to methods and systems for communication between wireless power transmitters and wireless power receivers and, more specifically, methods and systems for preventing communication issues among wireless power transmitters and receivers.

### BACKGROUND

Vehicles that have wireless power receivers may seek to park in parking spots enabled with wireless power transmitters. For instance, when such a vehicle approaches an area with two or more parking spots having transmitters, the receiver may not correctly or efficiently establish a connection with an available transmitter.

### SUMMARY

At least one aspect of the present disclosure is directed to a method for pairing a wireless power receiver to a wireless power transmitter. The wireless power receiver is configured to charge a battery of a vehicle. The method includes accessing, identification information associated with a communication channel corresponding to a designated wireless power transmitter of a plurality of wireless power transmitters, establishing, by the wireless power receiver, a wireless connection with the designated wireless power transmitter, based on the identification information associated with the communication channel, receiving, by the wireless power receiver over the wireless connection, alignment information from the designated wireless power transmitter, detecting that the vehicle has parked proximate to the designated wireless power transmitter according to the alignment information, and verifying that the wireless power receiver is authorized to receive power from the designated wireless power transmitter to charge the battery of the vehicle.

In some embodiments, the method includes determining that the wireless power receiver is to be paired to the designated wireless power transmitter, wherein the accessing of the identification information is in response to the determination. In one embodiment, the designated wireless power transmitter is pre-assigned to the wireless power receiver. In various embodiments, the communication channel is pre-assigned to the designated wireless power transmitter. In certain embodiments, the method includes verifying that the wireless power receiver is authorized to connect to the communication channel corresponding to the designated wireless power transmitter.

In one embodiment, verifying that the wireless power receiver is authorized to connect to the communication channel corresponding to the designated wireless power transmitter comprises verifying that a user associated with the wireless power receiver is authorized to obtain power from the designated wireless power transmitter. In some embodiments, accessing the identification information includes displaying, via a user interface, identification information associated with a plurality of communication channels, receiving, via the user interface, a selection of one of the plurality of communication channels, and designating a wireless power transmitter corresponding to the selected communication channel as the designated wireless transmitter. In certain embodiments, the method includes requesting authorization to establish the connection between the wireless power receiver and the designated wireless power transmitter. In various embodiments, the method includes displaying, via a user interface and in response to a determination that the wireless power receiver is not to be paired with the designated wireless transmitter, identification information associated with a plurality of communication channels and receiving, via the user interface, a selection of one of the plurality of communication channels.

In some embodiments, the plurality of communication channels correspond to the plurality of wireless transmitters other than the designated wireless transmitter. In one embodiment, the method includes establishing, by the wireless power receiver, a wireless connection with a second wireless power transmitter corresponding to the selected communication channel, based on the identification information of the selected communication channel, receiving, by the wireless power receiver over the wireless connection, alignment information from the second wireless power transmitter, detecting that the vehicle has parked proximate to the second wireless power transmitter according to the alignment information, and verifying that the wireless power receiver is authorized to receive power from the second wireless power transmitter to charge the battery of the vehicle. In various embodiments, the identification information associated with the communication channel includes a Service Set Identifier (SSID) associated with the designated wireless power transmitter.

Another aspect of the present disclosure is directed to a wireless power receiver for a vehicle. The wireless power receiver includes a wireless network interface and a processor in communication with the network interface. The processor is configured to access identification information associated with a communication channel corresponding to a designated wireless power transmitter of a plurality of wireless power transmitters, establish a wireless connection to the designated wireless power transmitter based on the identification information associated with the communication channel, receive, over the wireless connection, alignment information from the designated wireless power transmitter, detect that the vehicle has parked proximate to the designated wireless power transmitter according to the alignment information, and verify that the wireless power receiver is authorized to receive power from the designated wireless power transmitter to charge the battery of the vehicle.

In one embodiment, the processor is configured to determine that the wireless power receiver is to be paired to the designated wireless power transmitter, wherein the accessing of the identification information is in response to the determination. In some embodiments, the designated wireless power transmitter is pre-assigned to the wireless power receiver. In various embodiments, the communication channel is pre-assigned to the designated wireless power transmitter. In certain embodiments, the processor is configured to verify that the wireless power receiver is authorized to connect to the communication channel corresponding to the designated wireless power transmitter.

In some embodiments, the processor is configured to verify that the wireless power receiver is authorized to connect to the communication channel corresponding to the designated wireless power transmitter by verifying that a user associated with the wireless power receiver is authorized to obtain power from the designated wireless power transmitter. In one embodiment, the wireless power receiver includes a user interface and the processor is configured to access the identification information by displaying, via the user interface, identification information associated with a plurality of communication channels, receiving, via the user interface, a selection of one of the plurality of communication channels, and designating a wireless power transmitter corresponding to the selected communication channel as the designated wireless transmitter. In various embodiments, the processor is configured to request authorization to establish the connection between the wireless power receiver and the designated wireless power transmitter. In certain embodiments, the wireless power receiver includes a user interface and the processor is configured to display, via the user interface and in response to a determination that the wireless power receiver is not to be paired with the designated wireless transmitter, identification information associated with a plurality of communication channels, and receive, via the user interface, a selection of one of the plurality of communication channels.

In one embodiment, the plurality of communication channels correspond to the plurality of wireless transmitters other than the designated wireless transmitter. In some embodiments, the processor is configured to establish a wireless connection with a second wireless power transmitter corresponding to the selected communication channel, based on the identification information of the selected communication channel, receive, over the wireless connection, alignment information from the second wireless power transmitter, detect that the vehicle has parked proximate to the second wireless power transmitter according to the alignment information, and verify that the wireless power receiver is authorized to receive power from the second wireless power transmitter to charge the battery of the vehicle.

### BRIEF DESCRIPTION OF THE DRAWINGS

FIG. 1 is a block diagram of an exemplary wireless power system.

FIG. 2 is a diagram of an example vehicle charging environment including a parking facility with multiple wireless charging stations for use by vehicles.

FIG. 3 is a flowchart of an example method for connecting a vehicle assembly (VA) of an approaching vehicle to a ground assembly (GA) of a set of GAs of FIG. 2 in accordance with aspects described herein.

FIG. 4 is a flowchart of an example method for connecting a vehicle assembly (VA) of an approaching vehicle to a ground assembly (GA) of a set of GAs of FIG. 2 in accordance with aspects described herein.

FIG. 5 is a diagram of an example sequence for connecting a vehicle assembly (VA) of an approaching vehicle to a ground assembly (GA) of a set of GAs of FIG. 2 in accordance with aspects described herein.

FIGS. 6A-6B are flowcharts of an example method for connecting a vehicle assembly (VA) of an approaching vehicle to a ground assembly (GA) of a set of GAs of FIG. 2 in accordance with aspects described herein.

FIG. 7 is a block diagram of an example computer system that may be used in implementing the systems and methods described herein.

### DETAILED DESCRIPTION

Disclosed herein are exemplary embodiments of systems and methods for providing communication between wireless power transmitters and wireless power receivers and, more specifically, methods and systems for preventing connection issues between wireless power transmitters and receivers.

### Wireless Power Systems

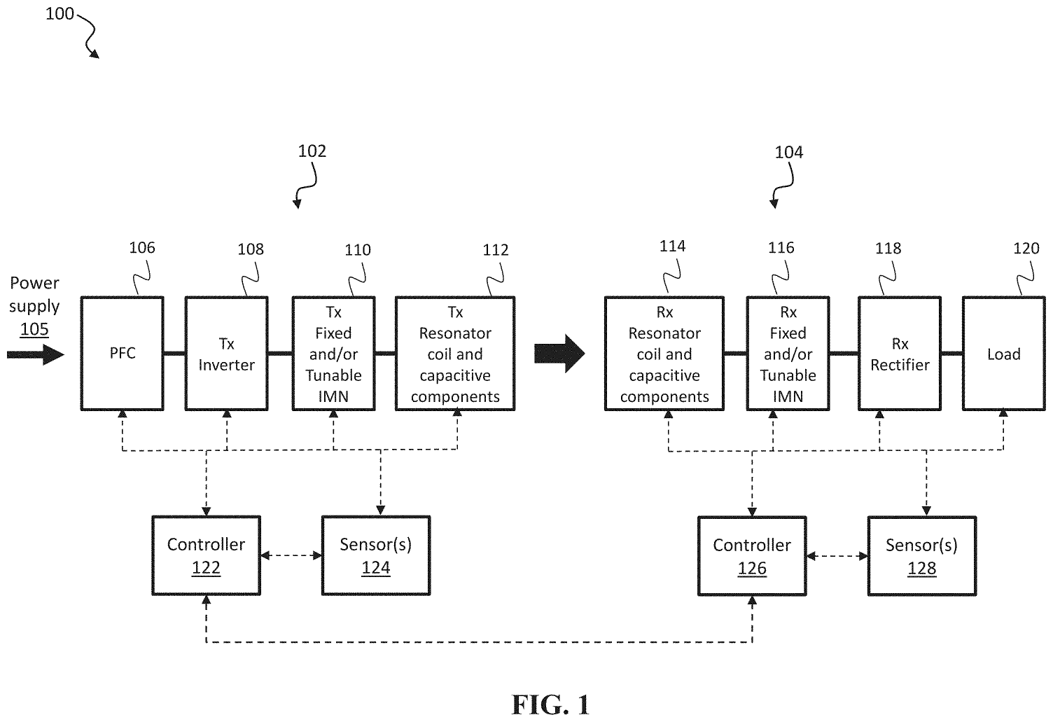

FIG. 1 is a block diagram of an exemplary wireless power system 100 including the exemplary system for auxiliary power dropout protection. The system 100 includes a wireless power transmitter 102 and a wireless power receiver 104. In transmitter 102, a power supply 105 (e.g., AC mains, battery, etc.) provides power to an inverter 108. Additional components can include power factor correction (PFC) circuit 106 before the inverter stage 108. The inverter 108 drives the transmitter resonator coil and capacitive components 112 (“resonator”), via an impedance matching network 110 (including fixed or tunable network components). The resonator 112 produces an oscillating magnetic field which induces a current and voltage in receiver resonator 114. The received energy is provided to a rectifier 118 via impedance matching network 116 (including fixed or tunable network components). Ultimately, the rectified power is provided to a load 120 (e.g., one or more batteries of an electric or hybrid vehicle). In some embodiments, the battery voltage level can impact various parameters (e.g., impedance) of the wireless power system 100. Therefore, the battery voltage level may be received, determined, or measured to be provided as input to other portions of the wireless power system 100. For example, typical battery voltage ranges for electric vehicles include 280 V-420 V, etc.

In some embodiments, one or more components of the transmitter 102 can be coupled to a controller 122, which may include a communication module (e.g., Wi-Fi, radio, Bluetooth, in-band signaling mechanism, etc.). In some embodiments, one or more components of the transmitter 102 can be coupled to one or more sensors 124 (e.g., current sensor(s), voltage sensor(s), power sensor(s), temperature sensor(s), fault sensor(s), etc.). The controller 122 and sensor(s) 124 can be operably coupled to control portions of the transmitter 102 based on feedback signals from the sensor(s) 124 and sensor(s) 128.

In some embodiments, one or more components of the receiver 104 can be coupled to a controller 126, which may include a communication module (e.g., Wi-Fi, radio, Bluetooth, in-band signaling mechanism, etc.). In some embodiments, one or more components of the transmitter 102 can be coupled to one or more sensors 128 (e.g., current sensor(s), voltage sensor(s), power sensor(s), temperature sensor(s), fault sensor(s), etc.). The controller 126 and sensor(s) 128 can be operably coupled to control portions of the transmitter 102 based on feedback signals from the sensor(s) 124 and sensor(s) 128.

Examples of wireless power systems can be found in U.S. Patent Application Publication No. 2010/0141042, published Jun. 10, 2010 and titled “Wireless energy transfer systems,” and U.S. Patent Application Publication No. 2012/0112535, published May 10, 2012 and titled “Wireless energy transfer for vehicles,” both of which are hereby incorporated by reference in their entireties.

In some embodiments, the exemplary impedance matching networks 110, 116 can include one or more variable impedance components. The one or more variable impedance components may be referred together herein as a “tunable matching network” (TMN). TMNs can be used in adjusting the impedance (e.g., including the reactance) of the wireless power transmitter 102 or receiver 104. In some embodiments, tunable matching network(s) may be referred to as “tunable reactance circuit(s)”. In some applications, e.g., wireless power transmission, impedances seen by the wireless power transmitter 102 and receiver 104 may vary dynamically. In such applications, impedance matching between a receiver resonator coil (of 114) and a load 120, and a transmitter resonator coil (of 112) and the inverter 108, may be required to prevent unnecessary energy losses and excess heat.

The impedance experienced by a resonator coil may be dynamic, in which case, a dynamic impedance matching network can be provided to match the varying impedance to improve the performance (e.g., efficiency, power delivery, etc.) of the system 100. In the case of the power supply 105 in a wireless power system 100, the impedances loading the inverter 108 may be highly variable because of changes in the load 120 receiving power (e.g., battery or battery charging circuitry) and changes in the coupling between the transmitter 102 and receiver 104 (caused, for example, by changes in the relative position of the transmitter and receiver resonator coils). Similarly, the impedance loading the receiver resonator 114 may also change dynamically because of changes in the load 120 receiving power. In addition, the desired impedance matching for the receiver resonator 114 may be different for different coupling conditions or power supply conditions.

Accordingly, power transmission systems transmitting or receiving power via highly resonant wireless power transfer, for example, may be required to configure or modify impedance matching networks 110, 116 to maintain efficient power transmission. One or more components of the TMN can be configured to present an impedance between a minimum impedance and a maximum impedance attainable by the particular components. In various embodiments, the attainable impedance can be dependent on the operating frequency (e.g., 80 kHz to 90 kHz) of the wireless power system 100. This configuration may be performed continuously, intermittently, or at certain points in power transmission (e.g., at the beginning of power transmission). Examples of tunable matching networks can be found in U.S. Patent Application Publication No. 2017/0217325, published Aug. 3, 2017 and titled “Controlling Wireless Power Transfer Systems,” and U.S. Patent Application Publication No. 2017/0229917, published Aug. 10, 2017 and titled “PWM Capacitor Control,” both of which are hereby incorporated by reference in their entireties.

High-power wireless power transmitters can be configured to transmit wireless power in applications such as powering of or charging a battery of vehicles, industrial machines, robots, or electronic devices relying on high power. For the purpose of illustration, the following disclosure focuses on wireless power transmission for vehicles (e.g., electric vehicles, hybrid vehicles, etc.). However, it is understood that any one or more of the embodiments described herein can be applied to other applications in which wireless power can be utilized.

### Connections Between Wireless Power Transmitters and Wireless Power Receivers

One aspect of wireless charging (e.g., of vehicles) to be addressed is establishing network communications between a wireless power receiver of the vehicle and the wireless power transmitter proximate to which the vehicle is parked. This establishment of network communications may be challenging in a residential setting with multiple wireless power transmitters at which multiple vehicles may be attempting to park at the same time or near the same time. In some cases, the example connection methods and systems discussed herein are beneficial for residential settings (e.g., a house, a condominium, apartment building, a multi-unit residence, etc.) having two or more wireless power transmitters. However, it is understood that one or more of the connection methods and systems may be used in commercial settings (e.g., a shopping mall, office, government building, school, etc.) having two or more wireless power transmitters. In some embodiments, the example connection methods and systems implemented in a commercial setting can include one or more security features including, e.g., an authentication step before initiating connection.

Wireless charging for residential settings may be considered a “private” use while wireless charging for commercial settings may be considered a “public” use. As discussed herein, a wireless power transmitter may be referred to as a “ground assembly” or “GA” and a wireless power receiver may be referred to as a “vehicle assembly” or “VA”.

As an example of one particular problem, a VA may establish network communications with a GA in an adjacent parking spot, determining that it has established communication with the correct wireless charging station in its own parking spot. When the VA requests power and does not receive it (because it is in communication with the wrong GA), the VA may not detect the source of the problem. Likewise, the GA in the adjacent parking spot may detect a fault because it is providing power and recognizing no load (e.g., of the vehicle). This problem may be referred to as “cross-connect.” In addition to the primary function of providing power being compromised in a cross-connect situation, additional features (e.g., vehicle alignment guidance) and safety features (e.g., foreign object detection, living object detection, etc.) may not operate properly, if at all, when communications are not established between the VA and the correct GA.

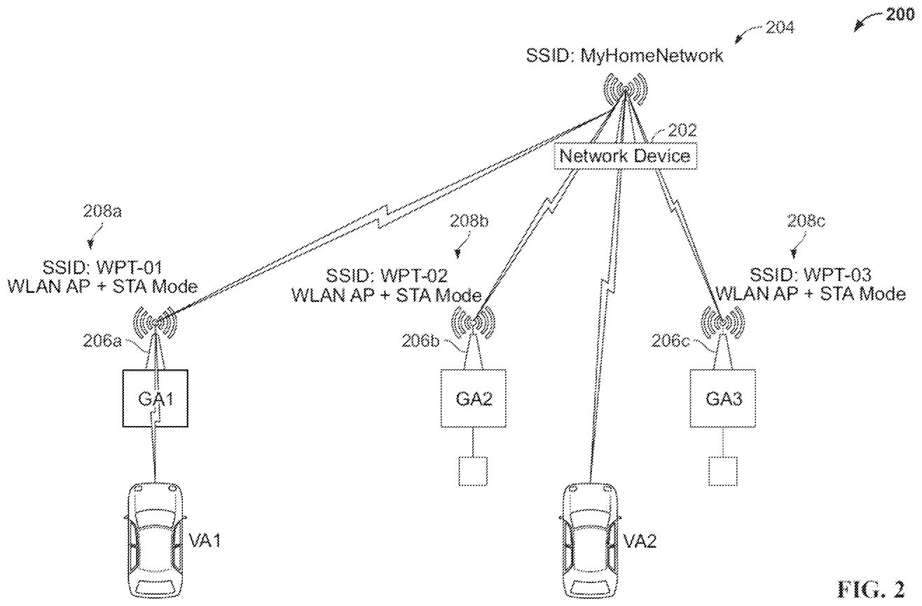

FIG. 2 illustrates an example vehicle charging environment 200 including a parking facility with multiple wireless charging stations for use by vehicles. The environment 200 may be part of or adjacent to a residence. As shown in the illustrated example, multiple GAs (e.g., GA1, GA2, GA3) are in communication with a network device 202. The network device 202 may include a router, an access point, or a switch, or devices combining such functions. Any suitable number of GAs can be implemented. The network device 202 provides, or is in communication with, a first wireless network 204 with a network Service Set Identifier (SSID) (e.g., “MyHomeNetwork”). For example, the network device 202 may be a home Wi-Fi router associated with a household (e.g., of a driver of one or more VAs). In another example, the network may be provided by a wireless access point that may be a stand-alone device or part of other network infrastructure in communication with the network device 202 through other mechanisms, including a wired network or an internal data bus. While Wi-Fi (IEEE 802.11) can be used in the environment 200 and generally herein as an example communication standard used for illustration, other network physical layers and higher-level protocols may also or instead be used, e.g., Bluetooth® or IEEE 802.15.4 (low-rate wireless networks, e.g., ZigBee®).

Each of the GAs (e.g., GA1, GA2, GA3) has a wireless network interface 206 (e.g., wireless network interfaces 206a, 206b, 206c, respectively), which can be configured to function as a wireless access point for its own private network 208 (e.g., 208a, 208b, 208c, respectively), indicated by network SSID names corresponding to the station's number: GA1 broadcasts a private network 208a with the network SSID WPT_01, GA2 broadcasts another private network 208b with the SSID WPT_02, and GA3 broadcasts another private network 208c with the SSID WPT_03. In some aspects, the GAs can communicate with the network device 202 over a network interface other than the wireless network interface 206. In the example scenario depicted in FIG. 2, GA1 is already connected to VA1 and using its own wireless network 208a to communicate with the VA1. The other wireless charging stations (e.g., GA2 and GA3) can use their respective network interfaces 206b, 206c to communicate with the network device 202 over the wireless network 204 with the network SSID “MyHomeNetwork.” In the example scenario of FIG. 2, a vehicle having a vehicle assembly VA2 may approach the parking environment 200 having two or more GAs in a search for a place to park and charge. In some embodiments, an approaching VA is more at risk of the cross-connect issues described above when there are one or more VAs connected to the network device 202 and approaching GAs in the environment 200. In some cases, a VA that is already connected to a GA poses less of a cross-connect issue because it is typically at the end of the pairing process and over the GA.

The following describes various systems and methods for VA-to-GA pairing while avoiding the cross-connect issues described above. Note that each of the GAs, VAs, or the router can be configured to pair in at least one of the methods described below. The GAs, VAs, or the network device 202 can be configured at the time of install in the environment 200 (e.g., by a technician), also referred to as “an install-time configuration”. In some embodiments, it is more efficient for the GAs, VAs, or router to have one default configuration that requires little or no action (e.g., additional settings, change in configuration, etc.) by the installer at time of installation, but still provide flexibility to make a configuration change during installation if needed depending on the networking situation. In some embodiments, if the home Wi-Fi coverage does not reach the garage or parking area (i.e., where the GA would be physically located), one GA could assume the role of the router as the master access point and receive connections from other GAs and VAs. The master GA could provide internet access through an LTE connection (e.g., USB-cellular modem). This would be an example of a different network configuration (as compared to a default network configuration) that could be made at install time.

### Manual VA-GA Connection Methods

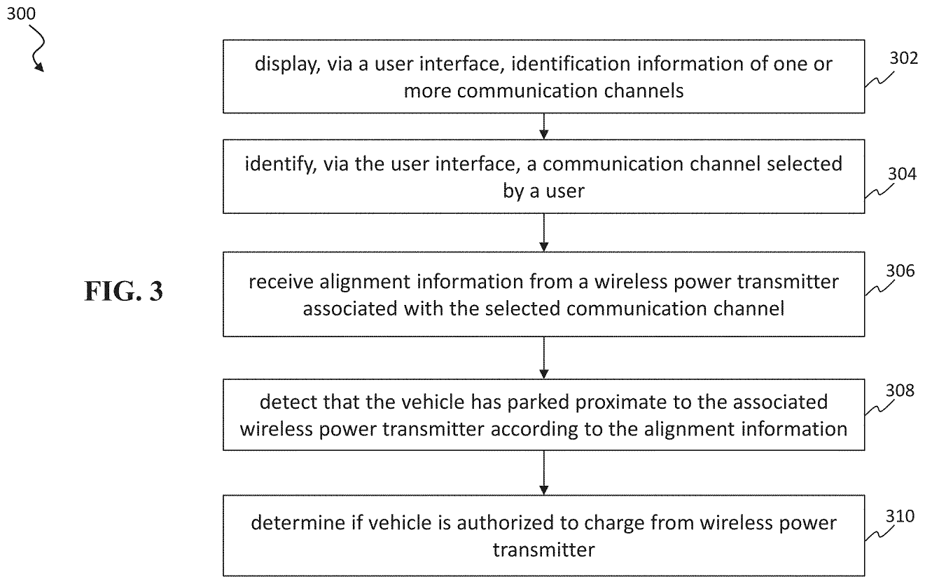

FIG. 3 provides an example method 300 for connecting the VA of the approaching vehicle to a GA of a set of GAs in accordance with aspects described herein. In one example, the method 300 corresponds to a manual VA-GA connection method. In some examples, the method 300 is configured to be carried out, at least in part, by a controller or processor associated with the VA of the approaching vehicle (e.g., the controller 122); however, in other examples, the method 300 may be carried out by a different controller or processer (e.g., a controller of the vehicle).

In one example, the VA of an approaching vehicle is pre-configured with connection parameters corresponding to one or more GAs (e.g., the set of GAs in FIG. 2). For example, a memory of the VA of the approaching vehicle (or the vehicle itself) can store identification information of one or more communication channels associated with the GAs (e.g., private networks 208a-208c). The identification information of the communication channels may be configured during an install-time configuration of the VA (or GAs) or using an in-vehicle display, user interface, or a corresponding mobile application. The identification information of the communication channels can include, for example, an SSID associated with each communication channel. In some examples, the VA is configured to connect to the network device 202 based on an install-time configuration. As such, as the vehicle enters the range (i.e., the radius within which a wireless signal can be received) of the network device 202, the VA may connect to the wireless network 204 provided by the network device 202. However, it should be appreciated that the connection of the VA (or the vehicle having the VA) to the wireless network 204 may be optional.

At step 302, as the vehicle approaches the one or more GAs, the identification information associated with the communication channels is displayed to the user via the user interface (e.g., in-vehicle display). In one example, the VA (or the vehicle) can detect that the vehicle is approaching the one or more GAs based on a detection of the GA communication channels. In other examples, the VA (or vehicle) may detect that the vehicle is approaching the one or more GAs based on a detection of the wireless network 204 or a connection to the wireless network 204. In some examples, the identification information is stored in memory and accessed via the controller 122 (or a different controller or processor). In one example, the user interface is configured to display an identifier of each communication channel (e.g., SSID, nickname, etc.). In other examples, the user interface may display an identifier (e.g., number, picture, symbol, etc.) of the GA corresponding to each connection channel (e.g., GA1). In some examples, the user interface is configured to display identifiers corresponding to the parking spots associated with the GAs (e.g., Spot 1). By automatically displaying the one or more available GAs to the user via the user interface, the user can view the GAs without needing to take any actions that may distract or burden the user. As such, the user can easily view the one or more available GAs and may continue to safely operate the vehicle while approaching the parking spots.

At step 304, a user-selected identification information (associated with the GA communication channel) is identified via the user interface. In one example, the in-vehicle display is a touchscreen and the user can select the identification information by tapping on the display. For example, the user may press a “connect” button corresponding to a desired communication channel (i.e., GA). The user may select the desired communication channel while approaching the corresponding GA or after having positioned the vehicle close to (or over) the corresponding GA. In some examples, the VA may send a notification to the network device 202 (via the wireless network 204) that a communication channel has been selected and the network device 202 may notify the corresponding GA. Once the GA communication channel is selected, the VA can connect to the selected GA directly based on the identification information of the selected communication channel (e.g., the SSID). In one example, the VA is configured to connect to the private network of the GA (e.g., private network 208a). In some examples, verification that the VA or a user associated with the VA is authorized to connect to the private network of the GA may be requested before the connection is established.

At step 306, the VA receives alignment information from the selected GA. In one example, the selected GA can send messages to the VA via the private network of the GA (e.g., private network 208a). The messages can include positioning data collected by the GA to help the vehicle having the VA align properly over the GA. The process can proceed (e.g., in a loop) until alignment is complete and the vehicle is put in park (step 308). In particular, the vehicle is parked proximate to the GA (e.g., over the GA) such that the VA is aligned to the GA for efficient power reception. For example, the GA or VA can detect whether alignment is complete.

At step 310, it is determined if the VA (or the vehicle having the VA) is authorized to charge from the GA. In one example, the VA (or vehicle) can be authorized to charge from the GA during an install-time configuration of the VA (or GAs) or using an in-vehicle display, user interface, or a corresponding mobile application. In some examples, charging authorization can be granted for one-time use, a period of use (e.g., one month), or permanent use. In certain examples, charging authorization of the VA may be granted by other users (e.g., a landlord, management company, charging service provider, etc.). Once charging authorization of the VA has been verified, the GA may begin providing power to charge the vehicle battery.

In one example, the user may press a “disconnect” button to disconnect the VA from the GA when leaving (or to stop charging). In other examples, the VA may automatically disconnect from the GA, or vice versa, when it has been detected that the user has driven away or that charging has been completed. In some examples, it can be detected that the user has driven away based on the velocity of the vehicle or a received signal strength indicator (RSSI) of a wireless network. For example, if the velocity of the vehicle increases, it may be determined that the user is driving away. Likewise, if the RSSI of the network signal received by the vehicle (i.e., the VA) is decreasing, it may be determined that the user is driving away. In one example, the RSSI of either the wireless network 204 or the private network of the GA (e.g., private network 208a) may be measured.

### Automatic VA-GA Connection Methods

In some examples, the user (i.e., driver) of the vehicle having the VA may consistently park in the same parking space and use the same GA for charging. As such, it may be advantageous for the VA to automatically connect to a GA without the user needing to select the GA before each charging session.

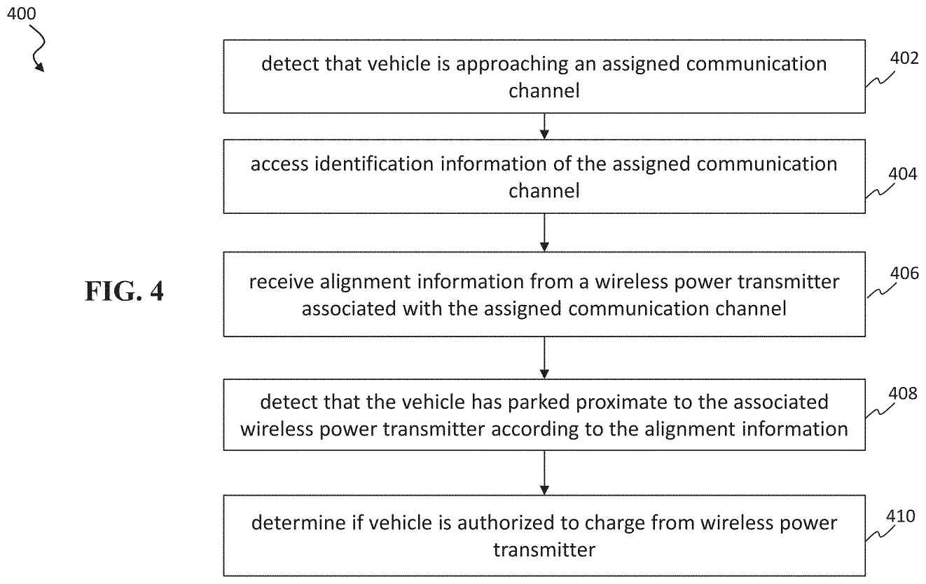

FIG. 4 provides an example method 400 for connecting the VA of the approaching vehicle to a GA of a set of GAs in accordance with aspects described herein. In one example, the method 400 corresponds to an automatic, pre-assigned VA-GA connection method. In some examples, the method 400 is configured to be carried out, at least in part, by a controller or processor associated with the VA of the approaching vehicle (e.g., the controller 122); however, in other examples, the method 400 may be carried out by a different controller or processer (e.g., a controller of the vehicle).

In one example, the VA of an approaching vehicle is pre-configured with connection parameters corresponding to a pre-assigned GA (i.e., a pre-assigned parking space). For example, a memory of the VA of the approaching vehicle (or the vehicle itself) may store identification information of a communication channel associated with the pre-assigned GA (e.g., private network 208a). The identification information of the communication channel may be configured during an install-time configuration of the VA (or GA) or using an in-vehicle display, user interface, or a corresponding mobile application. The identification information of the communication channels can include an SSID of each communication channel. In some examples, the VA is configured to connect to the network device 202 based on an install-time configuration. As such, as the vehicle enters the range of the network device 202, the VA may connect to the wireless network 204 provided by the network device 202. However, it should be appreciated that the connection of the VA (or the vehicle having the VA) to the wireless network 204 may be optional.

At step 402, it is detected that the VA (or the vehicle) is approaching a pre-assigned GA. In one example, the VA (or the vehicle) can detect that the vehicle is approaching the pre-assigned GA based on a detection of the GA communication channel. In other examples, the VA (or vehicle) may detect that the vehicle is approaching the assigned GA based on a detection of the wireless network 204 or a connection to the wireless network 204.

At step 404, the VA is configured to access identification information of the communication channel corresponding to the pre-assigned GA. In some examples, the identification information is stored in memory and accessed via the controller 126 (or a different controller or processor). Once the identification information is retrieved, the VA can connect to the pre-assigned GA directly based on the identification information of the communication channel (e.g., the SSID). In one example, the VA is configured to connect to the private network of the GA (e.g., private network 208a). In some examples, verification that the VA or a user associated with the VA is authorized to connect to the private network of the GA may be requested before the connection is established.

At step 406, the VA receives alignment information from the pre-assigned GA. In one example, the pre-assigned GA can send messages to the VA via the private network of the GA (e.g., private network 208a). The messages can include positioning data collected by the GA to help the vehicle having the VA align properly over the GA. The process can proceed (e.g., in a loop) until alignment is complete and the vehicle is put in park (step 408). In particular, the vehicle is parked proximate to the GA (e.g., over the GA) such that the VA is aligned to the GA for efficient power reception. For example, the GA or VA can detect whether alignment is complete.

At step 410, it is determined if the VA (or the vehicle housing the VA) is authorized to charge from the GA. In one example, the VA (or vehicle) can be authorized to charge from the GA during an install-time configuration of the VA (or GAs) or using an in-vehicle display, user interface, or a corresponding mobile application. In some examples, charging authorization can be granted for one-time use, a period of use (e.g., one month), or permanent use. In certain examples, charging authorization of the VA may be granted by other users (e.g., a landlord, management company, charging service provider, etc.). Once charging authorization of the VA has been verified, the GA may begin providing power to charge the vehicle battery.

In one example, the VA may automatically disconnect from the GA, or vice versa, when it has been detected that the user has driven away or that charging has been completed. In other examples, the user may press a “disconnect” button to disconnect the VA from the GA when leaving (or to stop charging). In some examples, it can be detected that the user has driven away based on the velocity of the vehicle or a received signal strength indicator (RSSI) of a wireless network. For example, if the velocity of the vehicle increases, it may be determined that the user is driving away. Likewise, if the RSSI of the network as measured by the vehicle (i.e., the VA) is decreasing, it may be determined that the user is driving away. In one example, the RSSI can be measured with reference to the wireless network 204 or the private network of the GA (e.g., private network 208a).

### Hybrid VA-GA Connection Methods

While the method 400 described above provides an automatic connection to a pre-assigned GA, it may be beneficial for the user (i.e., driver) of the vehicle having the VA to have the flexibility to select a different GA (or parking space) if needed. For example, if someone is parked in the user's pre-assigned parking space, they user may need to select a different GA for charging.

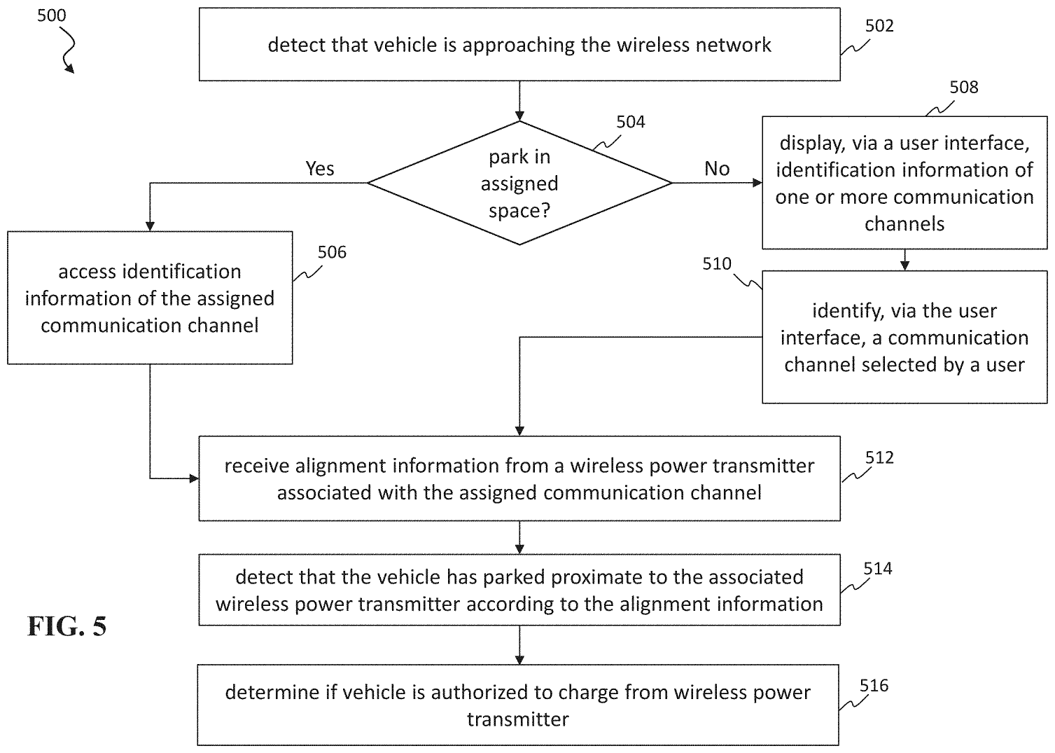

FIG. 5 provides an example method 500 for connecting the VA of the approaching vehicle to a GA of a set of GAs in accordance with aspects described herein. In one example, the method 500 corresponds to a hybrid VA-GA connection method. In some examples, the method 500 is configured to be carried out, at least in part, by a controller or processor associated with the VA of the approaching vehicle (e.g., the controller 122); however, in other examples, the method 500 may be carried out by a different controller or processer (e.g., a controller of the vehicle).

In one example, the VA of an approaching vehicle is pre-configured with connection parameters corresponding to one or more GAs (e.g., the set of GAs in FIG. 2). For example, the VA of the approaching vehicle (or the vehicle itself) can store identification information of one or more communication channels associated with the GAs (i.e., private networks 208a-208c). The identification information of the communication channels may be configured during an install-time configuration of the VA (or GAs) or using an in-vehicle display, user interface, or a corresponding mobile application. The identification information of the communication channels can include an SSID of each communication channel. In some examples, the VA is configured to connect to the network device 202 based on an install-time configuration. As such, as the vehicle enters the range of the network device 202, the VA may connect to the wireless network 204 provided by the network device 202. However, it should be appreciated that the connection of the VA (or the vehicle housing the VA) to the wireless network 204 may be optional.

At step 502, it is detected that the VA (or the vehicle) is approaching one or more GAs. In one example, the VA (or the vehicle) can detect that the vehicle is approaching the one or more GAs based on a detection of the GA communication channels. In other examples, the VA (or vehicle) may detect that the vehicle is approaching the one or more GAs based on a detection of the wireless network 204 or a connection to the wireless network 204.

At step 504, a processor can determine whether the user is planning to park in a pre-assigned parking space (having a pre-assigned GA). In some examples, the processor is the controller 126 of the VA or a different processor/controller in communication with the controller 126 of the VA (e.g., a controller of the vehicle). In one example, the user interface (e.g., in-vehicle display or a mobile device display) may display a prompt asking if the user would like to select a parking space other than the pre-assigned parking space. If no action is taken by the user, it can be assumed that the user is planning to park in the pre-assigned parking space. Likewise, if the user interacts with the prompt (or the user interface), it may be assumed that the user is planning to park in a different parking space.

At step 506, in response to a determination that the user intends to park the vehicle in the pre-assigned parking space, the VA is configured to access identification information of the communication channel corresponding to the pre-assigned GA. In some examples, the identification information is stored in memory and accessed via the controller 126 (or a different controller or processor). Once the identification information is retrieved, the VA can connect to the pre-assigned GA directly based on the identification information of the communication channel (e.g., the SSID). In one example, the VA is configured to connect to the private network of the GA (e.g., private network 208a). In some examples, verification that the VA or a user associated with the VA is authorized to connect to the private network of the pre-assigned GA may be requested before the connection is established. After the VA has connected to the GA, the method 500 continues to step 512.

Alternatively, at step 508, in response to a determination that the user does not intend to park the vehicle in the pre-assigned parking space, the identification information associated with one or more communication channels is displayed to the user via the user interface (e.g., in-vehicle display). In some examples, the identification information is stored in memory and accessed via the controller 122 (or a different controller or processor). In one example, the user interface is configured to display an identifier of each communication channel (e.g., SSID, nickname, etc.). In other examples, the user interface may display an identifier (e.g., number, picture, symbol, etc.) of the GA corresponding to each connection channel (e.g., GA1). In some examples, the user interface is configured to display identifiers corresponding to the parking spots associated with the GAs (e.g., Spot 1). By automatically displaying the one or more available GAs to the user via the user interface, the user can view the GAs without needing to take any actions that may distract or burden the user. As such, the user can easily view the one or more available GAs and may continue to safely operate the vehicle while approaching the parking spots.

At step 510, a user-selected identification information associated with a communication channel is identified (e.g., received, determined, etc.) via the user interface. In one example, the in-vehicle display is a touchscreen and the user can select the communication channel by tapping on the display. The user may select the desired communication channel while approaching the corresponding GA or after having positioned the vehicle close to (or over) the corresponding GA. In some examples, the VA may send a notification to the network device 202 (via the wireless network 204) that a communication channel has been selected and the network device 202 may notify the corresponding GA. Once the GA communication channel is selected, the VA can connect to the selected GA directly based on the identification information of the selected communication channel (e.g., the SSID). In one example, the VA is configured to connect to the private network of the GA (e.g., private network 208a). In some examples, verification that the VA or a user associated with the VA is authorized to connect to the private network of the GA may be requested before the connection is established.

At step 512, the VA receives alignment information from the selected or pre-assigned GA. In one example, the GA can send messages to the VA via the private network of the GA (e.g., private network 208a). The messages can include positioning data collected by the GA to help the vehicle having the VA align properly over the GA. The process can proceed (e.g., in a loop) until alignment is complete and the vehicle is put in park (step 514). In particular, the vehicle is parked proximate to the GA (e.g., over the GA) such that the VA is aligned to the GA for efficient power reception.

At step 516, it is determined if the VA (or the vehicle having the VA) is authorized to charge from the GA. In one example, the VA (or vehicle) can be authorized to charge from the GA during an install-time configuration of the VA (or GAs) or using an in-vehicle display, user interface, or a corresponding mobile application. In some examples, charging authorization can be granted for one-time use, a period of use (e.g., one month), or permanent use. In certain examples, charging authorization of the VA may be granted by other users (e.g., a landlord, management company, charging service provider, etc.). Once charging authorization of the VA has been verified, the GA may begin providing power to charge the vehicle battery.

In one example, the VA may automatically disconnect from the GA, or vice versa, when it has been detected that the user has driven away or that charging has been completed. In other examples, the user may press a “disconnect” button to disconnect the VA from the GA when leaving (or to stop charging). In some examples, it can be detected that the user has driven away based on the velocity of the vehicle or a received signal strength indicator (RSSI) of a wireless network. For example, if the velocity of the vehicle increases, it may be determined that the user is driving away. Likewise, if the RSSI of the network as measured by the vehicle (i.e., the VA) is decreasing, it may be determined that the user is driving away. In one example, the RSSI can be measured with reference to the wireless network 204 or the private network of the GA (e.g., private network 208a).

As described above, the methods 300, 400, and 500 are configured to be carried out, at least in part, by a controller or processor associated with the VA of the approaching vehicle (e.g., the controller 122); however, in other examples, the methods may be carried out by a different controller or processer (e.g., a controller of the vehicle). In some examples, at least a portion of the steps of methods 300, 400, and 500 may include the use of a cloud application or a user application. For example, the cloud application may communicate (e.g., send and receive messages) with the one or more GAs via the network device 202. Likewise, the user application may communicate with the one or more GAs via the cloud application.

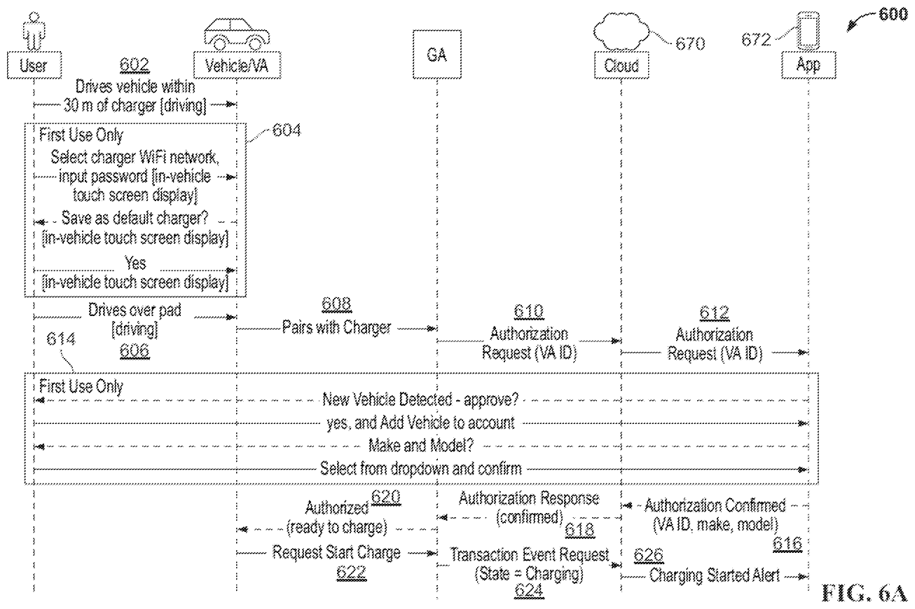

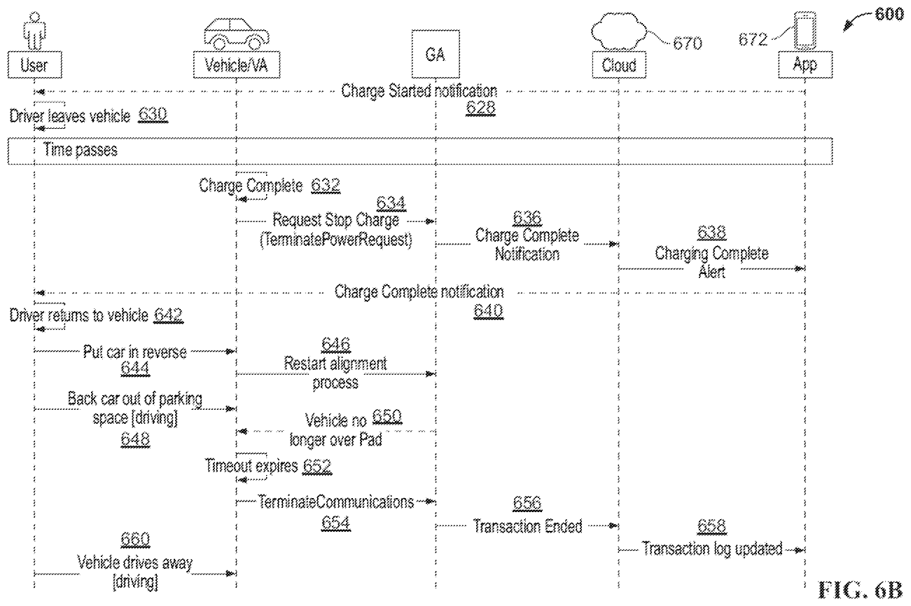

FIGS. 6A and 6B provide an example sequence 600 for connecting a VA of an approaching vehicle to a GA of one or more GAs in accordance with aspects described herein. In one example, at least a portion of the sequence 600 corresponds the hybrid VA-GA connection method 500 of FIG. 5.

As shown in FIG. 6A, in process 602, the user drives the vehicle having the VA towards the one or more GAs (e.g., the set of GAs in FIG. 2). As described above, the VA may be configured to connect to the network device 202 based on an install-time configuration. As such, as the vehicle enters the range (e.g., 30 meters) of the network device 202, the VA may connect to the wireless network 204 provided by the network device 202 (step 502).

In process 604, if it is the first time using the vehicle (or the VA) with the one or more GAs, the user may be prompted to provide additional information. In one example, the user interface (e.g., in-vehicle display) is configured to display the identification information associated with one or more communication channels corresponding to the respective one or more GAs. The user can select the identification information associated with one of the communication channels (i.e., GAs) to connect to. In some examples, the user may be prompted to enter a password for the selected identification information. After selecting the identification information, the user can save the GA corresponding to the selected identification information as the default GA (i.e., the pre-assigned parking space). If it is not the first time using the vehicle (or the VA) with the one or more GAs, the process 604 can be skipped.

In process 606, the user positions the vehicle close to (or over) a desired GA. In some examples, as the user is approaching the desired GA, it can be determined if the user is planning to park in the pre-assigned parking space having the default GA (step 504). In one example, the user interface (e.g., in-vehicle display) may display a prompt asking if the user would like to select a parking space other than the pre-assigned parking space. If no action is taken by the user, it can be assumed that the user is planning to park in the pre-assigned parking space. Likewise, if the user interacts with the prompt (or the user interface), it may be assumed that the user is planning to park in a different parking space.

In response to a determination that the user intends to park the vehicle in the pre-assigned parking space, the VA is configured to access identification information of the communication channel corresponding to the pre-assigned GA (step 506). In some examples, the identification information is stored in memory and accessed via the controller 122 (or a different controller or processor).

Likewise, in response to a determination that the user does not intend to park the vehicle in the pre-assigned parking space, the user interface (e.g., in-vehicle display) is configured to display the identification information of the communication channels to the user (step 508). In some examples, the identification information is stored in memory and accessed via the controller 122 (or a different controller or processor). In one example, the user interface is configured to display an identifier of each communication channel (e.g., SSID, nickname, etc.). In other examples, the user interface may display an identifier of the GA corresponding to each connection channel (e.g., GA1). A user-selected communication channel can be identified via the user interface (step 510). For example, the in-vehicle display may be a touchscreen and the user can select the communication channel by tapping on the display.

In some examples, the VA can receive alignment information from the selected or pre-assigned GA. In one example, the GA can start sending messages to the VA via the network device 202. The messages can include positioning data collected by the GA to help the vehicle having the VA align properly over the GA. The process can proceed (e.g., in a loop) until alignment is complete and the vehicle is put in park (step 514). In particular, the vehicle is parked proximate to the GA (e.g., over the GA) such that the VA is aligned to the GA for efficient power reception. In some examples, the alignment information provided via communicating with the network device 202 may be optional.

In process 608, the VA is configured to pair with the selected or pre-assigned GA. In one example, the VA can establish a connection to the selected or pre-assigned GA directly based on the identification information of the communication channel (e.g., the SSID) (step 516). In process 610, once a connection is established between the VA and the GA, the GA can send an authorization request (e.g., VA ID) to a cloud application 670. In one example, the GA is configured to communicate with the cloud application 670 via a network connection (e.g., a Wi-Fi module of the GA).

In process 612, the cloud application 670 is configured to forward the authorization request to a user application 672. In some examples, the user application 672 is accessible to at least one person having the authority to grant access to the selected or pre-assigned GA. In certain examples, the user application 672 may be accessible to the user operating the vehicle having the VA; however, in other examples, the user application 672 may also be accessible to other users (e.g., a landlord, management company, etc.).

In process 614, if it is the first time using the vehicle (or the VA) with the selected or pre-assigned GA, the user may be prompted to provide additional information to authorize the vehicle to charge from the GA. In one example, the user application 672 is configured to prompt the user to approve a new vehicle that has been detected. The user may approve the vehicle and request to add (or save) the vehicle to the user's account. In response, the user application 672 may prompt the user to provide characteristics of the vehicle (e.g., make, model, etc.). Once confirmed, the vehicle can be saved to the user's account for future use. If it is not the first time using the vehicle (or the VA) with the selected or pre-assigned GA, the process 614 can be skipped.

In process 616, once authorization of the vehicle having the VA has been confirmed, the user application 672 is configured to send an authorization confirmation to the cloud application 670. In process 618, the cloud application 670 is configured to forward the authorization confirmation to the GA. In process 620, the GA is configured to notify the VA that the vehicle has been authorized and is ready for charging.

In process 622, the controller 122 of the VA is configured to send a request to the GA to start charging. In response, in process 624, the GA sends a transition event request to the cloud application 670. In one example, the transition event request provides an indication that the GA is operating in a charging state. In process 626, the cloud application 670 sends an alert to the user application 672 indicating that charging has started.

As shown in FIG. 6B, in process 628, the user receives a notification from the user application 672 that charging has started. In response, the user may exit the vehicle (process 630). In process 632, after a period of time has passed, the VA is configured to detect that charging has been completed (i.e., the vehicle battery is fully charged). As such, in process 634, the VA sends a request to stop charging to the GA. In process 636, the GA sends a charge complete notification to the cloud application 670. In process 638, the cloud application 670 is configured to send an alert to the user application 672 indicating that charging has been completed.

In process 640, the user receives a notification from the user application 672 that charging has been completed. In response, the user may return to the vehicle (process 642). In process 644, when the user is ready to leave, the vehicle is put in reverse. In process 646, based in the detection of vehicle movement, the VA may send a notification to the GA to restart (or resume) the alignment process. In process 648, the user backs the vehicle out of the parking space (i.e., away from the GA). In process 650, once the vehicle has moved out of the parking space, the GA sends a notification to the VA indicating that the vehicle is no longer positioned over the GA.

In process 652, after a timeout has expired (e.g., 20 secs) the controller 122 of the VA can determine that the vehicle has driven away from the parking space (i.e., the GA). As such, in process 654, the controller 122 of the VA is configured to terminate communication with the GA. In response, the GA sends a notification to the cloud application 670 indicating that the charging transaction has ended. In one example, the cloud application 670 may store a transaction log entry corresponding to the charging transaction. In process 658, the cloud application 670 sends a notification to the user application 672 that the transaction log has been updated. In process 660, the user drives away from the parking space.

### User Interface Considerations of VA-GA Pairing Methods

The tables below provide example user interface features for one or more of the VA-GA pairing methods described herein. In one example, Table 1 corresponds to the manual VA-GA connection method 300 of FIG. 3 and Table 2 corresponds to the automatic, pre-assigned VA-GA connection method 400 of FIG. 4. Likewise, Table 3 corresponds to the hybrid VA-GA connection method of FIG. 5 and the sequence 600 of FIGS. 6A and 6B.

TABLE 1
Example user interface features of
manual VA-GA connection method.

| Feature | Manual Connect/Disconnect, Driver's Choice of Parking |
|---|---|
| Description | Space |
| Wi-Fi | The in-vehicle display can show the saved network(s) |
| Connection | for each GA at the home. While approaching, the driver |
| Trigger | can manually press a “connect” button for one of the |
| | saved networks on the in-vehicle display to connect the VA |
| | to a GA of his/her choice. A “disconnect” button |
| | becomes available to disconnect and then connect to a |
| | different GA if desired. Connection does not happen auto- |
| | matically in this case. |
| Parking | Driver can select the GA to park over and is given the |
| Implications | option manually select it (e.g., through the in-vehicle |
| | display). |
| Potential UX | Prompts user intervention but enables more flexibility |
| Impact | and options for parking for the user. |

TABLE 2
Example user interface features of
automatic VA-GA connection method.

| Feature | |
|---|---|
| Description | Automatic Connection, Pre-Assigned Parking Space |
| Wi-Fi | VA can be pre-configured to automatically connect to |
| Connection | one of the GAs at the home when the VA comes within |
| Trigger | Wi-Fi range. |
| Parking | Driver can park over the pre-assigned GA for his/her |
| Implications | vehicle's VA. |
| Potential UX | No user intervention, but driver is limited to using |
| Impact | only the pre-assigned GA in this mode. Driver may |
| | forget and park over the wrong GA. |

TABLE 3
Example user interface features of
hybrid VA-GA connection method.

| Feature | |
|---|---|
| Description | Hybrid Connection |
| Wi-Fi | VA can be pre-configured to automatically connect to one |
| Connection | of the GAs at the home when the VA comes within Wi-Fi |
| Trigger | range, but the driver can manually disconnect the VA from |
| | that GA and connect to a GA of his/her choice. This |
| | allows for overriding the default GA and selecting |
| | a different available GA to park over. The in-vehicle |
| | display may present the option to “Automatically Connect” |
| | to the new manually selected GA next time. |
| Parking | Driver can park over the pre-assigned GA or manually |
| Implications | select a GA (e.g., through the in-vehicle display). |
| Potential UX | No user intervention unless overriding the default pairing. |
| Impact | Enables more flexibility and options for the user. |

### Hardware and Software Implementations

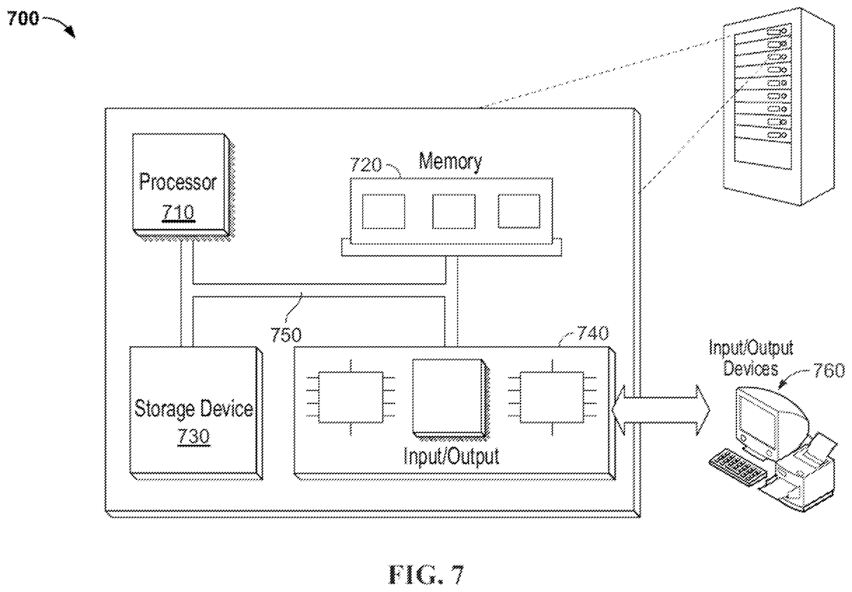

FIG. 7 is a block diagram of an example computer system 700 that may be used in implementing the systems and methods described herein. General-purpose computers, network appliances, mobile devices, or other electronic systems may also include at least portions of the system 700. The system 700 includes a processor 710, a memory 720, a storage device 730, and an input/output device 740. Each of the components 710, 720, 730, and 740 may be interconnected, for example, using a system bus 750. The processor 710 is capable of processing instructions for execution within the system 700. In some implementations, the processor 710 is a single-threaded processor. In some implementations, the processor 710 is a multi-threaded processor. The processor 710 is capable of processing instructions stored in the memory 720 or on the storage device 730.

The memory 720 stores information within the system 700. In some implementations, the memory 720 is a non-transitory computer-readable medium. In some implementations, the memory 720 is a volatile memory unit. In some implementations, the memory 720 is a nonvolatile memory unit. In some examples, some or all of the data described above can be stored on a personal computing device, in data storage hosted on one or more centralized computing devices, or via cloud-based storage. In some examples, some data are stored in one location and other data are stored in another location. In some examples, quantum computing can be used. In some examples, functional programming languages can be used. In some examples, electrical memory, such as flash-based memory, can be used.

The storage device 730 is capable of providing mass storage for the system 700. In some implementations, the storage device 730 is a non-transitory computer-readable medium. In various different implementations, the storage device 730 may include, for example, a hard disk device, an optical disk device, a solid-date drive, a flash drive, or some other large capacity storage device. For example, the storage device may store long-term data (e.g., database data, file system data, etc.). The input/output device 740 provides input/output operations for the system 700. In some implementations, the input/output device 740 may include one or more of a network interface devices, e.g., an Ethernet card, a serial communication device, e.g., an RS-232 port, or a wireless interface device, e.g., an 802.11 card, or a wireless modem. In some implementations, the input/output device may include driver devices configured to receive input data and send output data to other input/output devices, e.g., keyboard, printer and display devices 760. In some examples, mobile computing devices, mobile communication devices, and other devices may be used.

In some implementations, at least a portion of the approaches described above may be realized by instructions that upon execution cause one or more processing devices to carry out the processes and functions described above. Such instructions may include, for example, interpreted instructions such as script instructions, or executable code, or other instructions stored in a non-transitory computer readable medium. The storage device 730 may be implemented in a distributed way over a network, such as a server farm or a set of widely distributed servers, or may be implemented in a single computing device.

Although an example processing system has been described in FIG. 7, embodiments of the subject matter, functional operations and processes described in this specification can be implemented in other types of digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible nonvolatile program carrier for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “system” may encompass all kinds of apparatus, devices, and machines for processing data, including by way of example a programmable processor, a computer, or multiple processors or computers. A processing system may include special purpose logic circuitry, e.g., an FPGA (field programmable gate array) or an ASIC (application specific integrated circuit). A processing system may include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a standalone program or as a module, component, subroutine, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Computers suitable for the execution of a computer program can include, by way of example, general or special purpose microprocessors or both, or any other kind of central processing unit. Generally, a central processing unit will receive instructions and data from a read-only memory or a random access memory or both. A computer generally includes a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few.

Computer readable media suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD-ROM and DVD-ROM disks. The processor and the memory can be supplemented by, or incorporated in, special purpose logic circuitry.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single product or packaged into multiple products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other steps or stages may be provided, or steps or stages may be eliminated, from the described processes. Accordingly, other implementations are within the scope of the following claims.

### Terminology

The phraseology and terminology used herein is for the purpose of description and should not be regarded as limiting.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

What is claimed is:

1. A method for pairing a wireless power receiver to a wireless power transmitter, the wireless power receiver configured to charge a battery of a vehicle, the method comprising:
accessing, identification information associated with a communication channel corresponding to a designated wireless power transmitter of a plurality of wireless power transmitters;
establishing, by the wireless power receiver, a wireless connection with the designated wireless power transmitter, based on the identification information associated with the communication channel;
receiving, by the wireless power receiver over the wireless connection, alignment information from the designated wireless power transmitter;
detecting that the vehicle has parked proximate to the designated wireless power transmitter according to the alignment information; and
verifying that the wireless power receiver is authorized to receive power from the designated wireless power transmitter to charge the battery of the vehicle.

2. The method of claim 1, further comprising:
determining that the wireless power receiver is to be paired to the designated wireless power transmitter;
wherein the accessing of the identification information is in response to the determination.

3. The method of claim 1, wherein the designated wireless power transmitter is pre-assigned to the wireless power receiver.

4. The method of claim 1, wherein the communication channel is pre-assigned to the designated wireless power transmitter.

5. The method of claim 1, further comprising:
verifying that the wireless power receiver is authorized to connect to the communication channel corresponding to the designated wireless power transmitter.

6. The method of claim 5, wherein verifying that the wireless power receiver is authorized to connect to the communication channel corresponding to the designated wireless power transmitter comprises verifying that a user associated with the wireless power receiver is authorized to obtain power from the designated wireless power transmitter.

7. The method of claim 1, wherein accessing the identification information comprises:
displaying, via a user interface, identification information associated with a plurality of communication channels;
receiving, via the user interface, a selection of one of the plurality of communication channels; and
designating a wireless power transmitter corresponding to the selected communication channel as the designated wireless transmitter.

8. The method of claim 7, further comprising:
requesting authorization to establish the connection between the wireless power receiver and the designated wireless power transmitter.

9. The method of claim 1, further comprising:
displaying, via a user interface and in response to a determination that the wireless power receiver is not to be paired with the designated wireless transmitter, identification information associated with a plurality of communication channels; and
receiving, via the user interface, a selection of one of the plurality of communication channels.

10. The method of claim 9, wherein the plurality of communication channels correspond to the plurality of wireless transmitters other than the designated wireless transmitter.

11. The method of claim 9, further comprising:
establishing, by the wireless power receiver, a wireless connection with a second wireless power transmitter corresponding to the selected communication channel, based on the identification information of the selected communication channel;
receiving, by the wireless power receiver over the wireless connection, alignment information from the second wireless power transmitter;
detecting that the vehicle has parked proximate to the second wireless power transmitter according to the alignment information; and
verifying that the wireless power receiver is authorized to receive power from the second wireless power transmitter to charge the battery of the vehicle.

12. The method of claim 1, wherein the identification information associated with the communication channel includes a Service Set Identifier (SSID) associated with the designated wireless power transmitter.

13. A wireless power receiver for a vehicle, the wireless power receiver comprising:
a wireless network interface, and
a processor in communication with the network interface, and configured to:
access identification information associated with a communication channel corresponding to a designated wireless power transmitter of a plurality of wireless power transmitters;
establish a wireless connection to the designated wireless power transmitter based on the identification information associated with the communication channel;
receive, over the wireless connection, alignment information from the designated wireless power transmitter;
detect that the vehicle has parked proximate to the designated wireless power transmitter according to the alignment information; and
verify that the wireless power receiver is authorized to receive power from the designated wireless power transmitter to charge the battery of the vehicle.

14. The wireless power receiver of claim 13, wherein the processor is further configured to:
determine that the wireless power receiver is to be paired to the designated wireless power transmitter;
wherein the accessing of the identification information is in response to the determination.

15. The wireless power receiver of claim 13, wherein the designated wireless power transmitter is pre-assigned to the wireless power receiver.

16. The wireless power receiver of claim 13, wherein the communication channel is pre-assigned to the designated wireless power transmitter.

17. The wireless power receiver of claim 13, wherein the processor is further configured to:
verify that the wireless power receiver is authorized to connect to the communication channel corresponding to the designated wireless power transmitter.

18. The wireless power receiver of claim 17, wherein the processor is configured to verify that the wireless power receiver is authorized to connect to the communication channel corresponding to the designated wireless power transmitter by verifying that a user associated with the wireless power receiver is authorized to obtain power from the designated wireless power transmitter.

19. The wireless power receiver of claim 13, further comprising a user interface,
wherein the processor is configured to access the identification information by:
displaying, via the user interface, identification information associated with a plurality of communication channels;
receiving, via the user interface, a selection of one of the plurality of communication channels; and
designating a wireless power transmitter corresponding to the selected communication channel as the designated wireless transmitter.

20. The wireless power receiver of claim 19, wherein the processor is further configured to:
request authorization to establish the connection between the wireless power receiver and the designated wireless power transmitter.

21. The wireless power receiver of claim 13, further comprising a user interface, wherein the processor is configured to:
display, via the user interface and in response to a determination that the wireless power receiver is not to be paired with the designated wireless transmitter, identification information associated with a plurality of communication channels; and
receive, via the user interface, a selection of one of the plurality of communication channels.

22. The wireless power receiver of claim 21, wherein the plurality of communication channels correspond to the plurality of wireless transmitters other than the designated wireless transmitter.

23. The wireless power receiver of claim 21, wherein the processor is further configured to:
establish a wireless connection with a second wireless power transmitter corresponding to the selected communication channel, based on the identification information of the selected communication channel;
receive, over the wireless connection, alignment information from the second wireless power transmitter;
detect that the vehicle has parked proximate to the second wireless power transmitter according to the alignment information; and
verify that the wireless power receiver is authorized to receive power from the second wireless power transmitter to charge the battery of the vehicle.
